(19) United States
(12) Patent Application Publication
(10) Pub. No.: US 2014/0019424 A1
(43) Pub. Date: Jan. 16, 2014

(54) IDENTIFIER VALIDATION AND DEBUGGING

(71) Applicants: Eu-Jin Goh, Palo Alto, CA (US); Anusha Sriraman, Sunnyvale, CA (US)

(72) Inventors: Eu-Jin Goh, Palo Alto, CA (US); Anusha Sriraman, Sunnyvale, CA (US)

(73) Assignee: GOOGLE INC., Mountain View, CA (US)

(21) Appl. No.: 13/546,986

(22) Filed: Jul. 11, 2012

(51) Int. Cl. G06F 17/30

(52) U.S. Cl. 707/690; 707/E17.005

(57) ABSTRACT

Methods, systems, and apparatus, including computer programs encoded on a computer-readable storage medium, and including a method are provided where the method includes receiving information from a web publisher related to a presentation of a web property responsive to a user request, the information including an identifier associated with the content presented and an identifier associated with the user that viewed the web property; validating the information, including comparing the information to a separate information source that is provided by the web publisher including determining when the information is properly encoded and/or formatted; and when the information is unable to be validated, storing a record indicative of any invalid information.

### BACKGROUND

This specification relates to information processing.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors through prices offered by content sponsors as part of a reservation system, or by bid amounts used in an auction. For example, content sponsors can provide bids specifying amounts that the sponsors are respectively willing to pay for presentation of their content. In turn, an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include receiving information from a web publisher related to a presentation of a web property responsive to a user request; validating the information, including comparing the information to a separate information source that is provided by the web publisher; and when the information is unable to be validated, storing a record indicative of any invalid information.

These and other implementations can each optionally include one or more of the following features. The information can be in the form of a key pair. The information can include product information associated with the web property. The information can include an identifier. The identifier can be selected from a group comprising a product identifier, a hotel identifier, or a flight identifier. The information can be received responsive to a tag or pixel that fires coincident with a presentation of the web property to the user. The information can be specified by the web publisher.

The information can include user information that identifies the user. The user information can include a cookie that identifies the user. The method can further comprise forming a user list using the information. The method can further comprise determining a user list associated with the information and adding the user to the user list based on the information. Validating the information can comprise determining when the information is properly formatted. Validating the information can comprise determining when the information is correctly encoded.

The information can include a key pair including a product identifier, and validating the information can comprise locating the product identifier in data associated with the separate information source. The method can further comprise determining when the information corresponds to an existing user list, and adding the user to the user list. The separate information source can be a product feed. The product feed can be selected from a group comprising a product listings feed, a service listings, a hotel listings feed, or a flight listings feed.

Storing a record can include generating a report and providing the report to the web publisher, the report including the invalid information. The method can further comprise enabling the web publisher to target content to the user based on the information. The targeting can include either receipt of different bids based on the information or enabling the web publisher to provide different bids based on the information. The method can further comprise enabling a different entity to target content to the user based on the information.

In general, another innovative aspect of the subject matter described in this specification can be implemented in methods that include a method for receiving, coincident with a presentation of a web resource, information from a web publisher associated with the web resource that identifies tag attributes to be associated with a user viewing the web resource; validating the information including validating one or more of the tag attributes as against a separate information source that includes feed attributes where the feed attributes are used in developing one or more user lists, a user list having an attribute and including identifiers for one or more users that are associated with the user list and are characterized by the attribute; and when the information is invalid, providing a report to the web publisher that includes invalid information.

Other embodiments of this aspect include corresponding systems, apparatus, and computer programs, configured to perform the actions of the methods, encoded on computer storage devices.

Particular implementations may realize none, one or more of the following advantages. Information that is received responsive to a tag and/or pixel that is executed coincident with a presentation of a web property (e.g., a product image on a website) on a user device may or may not be valid. Received information can include an identifier, a name, and a description associated with the web property. Validity of the received information can be determined by checking whether that information can be located in data associated with a product feed. Information that is determined to be invalid can be stored and provided to web publishers. Web publishers can use the invalid information to identify and correct errors relating to the presentation of web properties.

User information can be received in connection with the received information. Additionally, user lists can be formed using the received information. Content can be targeted by a web publisher to a user based on the received information. Content targeting can be based in part on receipt (or automatic generation) of different bids based on the information. Moreover, a different entity can target content to the user based on the information.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for validating information.

FIG. 2 is a flowchart of an example process for validating information.

FIG. 3 illustrates an interaction between a client device and an example system for validating information.

FIG. 4 is a schematic diagram of an example server.

Like reference numbers and designations in the various drawings indicate like elements.

### DETAILED DESCRIPTION

Web publishers (e.g., advertisers, publishers, and service providers) generally may wish to identify content that a particular user accesses, purchases, or otherwise interacts with on the web publisher's website. The identification of such content can be used to further identify other content (e.g., advertisements) that may be meaningful to the user. In some instances, the identification of content that a user accesses, purchases, or interacts with may be rendered difficult due to errors relating to the presentation of the content. For example, a product “Product A” may be mislabeled as “Product B,” which does not exist. In this scenario, the web publisher may not be able to determine that a user is interacting with “Product A,” since the product has been incorrectly labeled as “Product B.”

Methods are described for validating content information (e.g., identifiers and labels) relating to the presentation of content by a web publisher. Information relating to content that is presented in response to a user request can be received from a web publisher. The content information can be received in response to a tag or pixel that fires (e.g., executes) when the content is presented to the user. The received content information can be validated by comparing the received information to information contained in a separate information source that is provided by the web publisher. Content information that is unable to be validated can be stored. A report can be generated using the content information that is unable to be validated. The generated report can be provided to the web publisher, and the report may be used to correct errors in the information relating to the presented content.

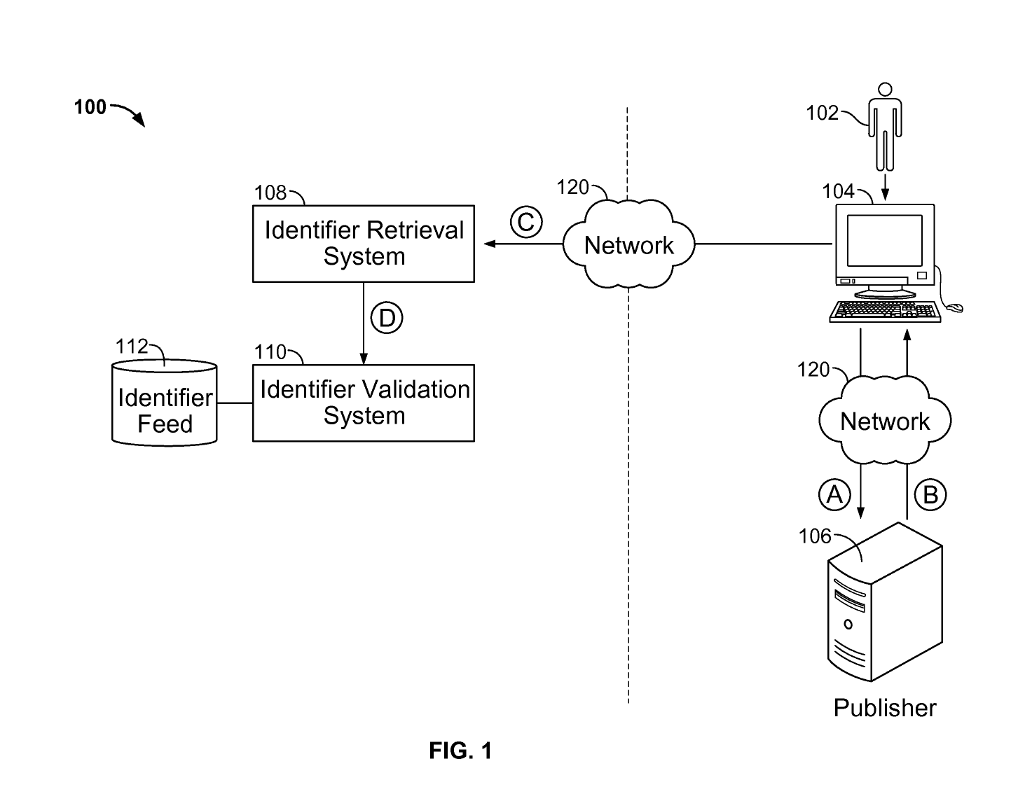

FIG. 1 is a diagram of an example system 100 for validating information. In general, the system 100 includes a client device 104, a publisher system 106, an identifier retrieval system 108, and an identifier validation system 110 in communication with an identifier feed 112.

A user 102 interacts with the client device 104 to communicate with the publisher system 106 over a network 120. The publisher system 106 can provide content for display (e.g., web pages) to the client device 104. The content provided by the publisher system 106 can include tags (e.g., client-side scripts) or pixels that can be associated with web properties (e.g., references to products, hotels, or flights) that are presented in connection with the content. The tags and/or pixels can be provided by web publishers that associate the tags and/or pixels with web properties (e.g., references to products, hotels, or flights) that are presented in connection with content provided by the web publisher. The tags and/or pixels can be configured to communicate information regarding the presented web properties to an information processing system (e.g., server implementing the identifier retrieval system 108). For example, tags and/or pixels can be used to communicate an identifier (e.g., an alphanumeric code) for a web property that represents a particular product, hotel, or flight.

The client device 104 can present the content received from the publisher system 106 to the user 102. In addition, the client device 104 can process tags and/or pixels included with the content to communicate information relating to web properties to the identifier retrieval system 108 over the network 120.

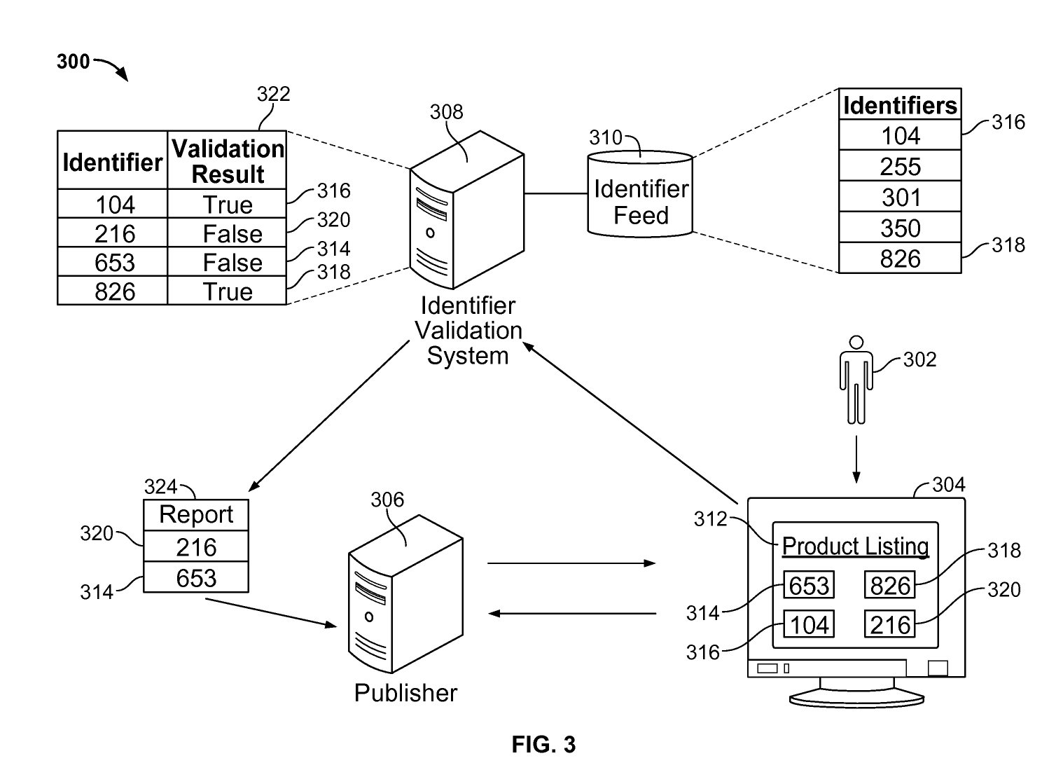

The identifier retrieval system 108 can communicate with the identifier validation system 110 over the network 120 to attempt to validate the information that was received from the client device 104. The identifier validation system 110 can validate the information using, for example, information contained in the identifier feed 112. The identifier feed 112 can include, for example, a listing of identifiers that correspond to various web properties (e.g., products, services, hotels, flights). The identifier feed 112 can be provided by a web publisher. A web publisher can specify information (e.g., identifiers) for the identifier feed 112, where the information (e.g., identifiers) is associated with web properties (e.g., references to products, hotels, or flights) that are presented in connection with content provided by the web publisher. For example, a web publisher can provide an identifier feed that includes identifiers “100,” “102,” and “104,” where the identifiers “100,” “102,” and “104,” correspond to products that are offered for sale on the web publisher's site. The use of an example identifier feed is discussed in more detail in connection with FIG. 3. In some implementations, the identifier validation system 110 validates the information received from the identifier retrieval system 108 by comparing the information to a listing of identifiers in the identifier feed 112. The identifier validation system 110 can determine that information received from the identifier retrieval system 108 is invalid when the information is not included in the identifier feed 112. For example, the identifier validation system 110 can receive information indicating that one or more users have purchased products that have identifiers “100,” “102,” and “400.” Assuming an example identifier feed that includes identifiers “100,” “102,” and “104” is provided, the identifier validation system 110 can determine that the purchases involving products with identifiers “100” and “102” refer to known products, since these identifiers are included in the identifier feed, and that the purchases involving products with the identifier “400” refer to an unknown product, since this identifier is not included in the identifier feed. The products using the identifier “400” can be reported to the web publisher for corrective measures.

As used by this specification, the network 120 may include, for example, a wireless cellular network, a wireless local area network (WLAN) or Wi-Fi network, mobile telecommunications network, such as a Third Generation (3G) or Fourth Generation (4G) mobile telecommunications network, a wired Ethernet network, a private network such as an intranet, a public network such as the Internet, or any appropriate combination thereof.

In FIG. 1, a user 102 interacts with a client device 104 to obtain content from a publisher system 106 during state (A). For example, the user 102 may use a graphical user interface (e.g., a web browser) to access web properties (e.g., images and data associated with products, services, hotels, or flights) from the publisher system 106. For example, the user 102 may access a website that is managed by the publisher system 106. The website can include a collection of web pages formatted in hypertext markup language (HTML) that contain web properties along with tags (e.g., client-side scripts) or pixels that are included in or correspond to the web properties.

The publisher system 106 communicates content, including web properties, to the client device 104 during state (B). The client device 104 can present the received web properties using a graphical user interface (e.g., web browser). For example, the publisher system 106 can communicate a web page containing a listing of products to the client device 104. In some implementations, the received web properties include tags or pixels that correspond to or are included in the web properties, such that presentation of the web properties results in executing the corresponding tags or pixels by the client device 104.

The client device 104 communicates the information resulting from the executed tags or pixels to the identifier retrieval system 108 during state (C). For example, the communicated information can include various information relating to a web property (e.g., an identifier, a name, a description, a vertical, a category), including user information identifying the user 102.

The identifier retrieval system 108 communicates the received information to the identifier validation system 110 for validation during state (D). The identifier validation system 110 validates the information using the identifier feed 112 by, for example, locating the information in data associated with the identifier feed 112. Information that is determined to be invalid can be stored and provided to web publishers in the form of a report. For example, web publishers can use the report to identify and correct errors relating to the presentation of web properties. For example, a web publisher use the report to update invalid identifiers that are being used in tags and/or pixels, such that subsequent execution of those tags and/or pixels results in transmission of the correct identifier for a given web property.

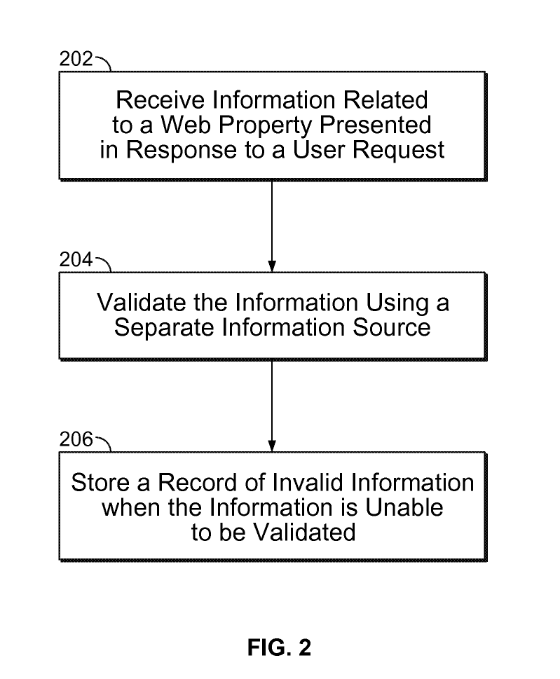

FIG. 2 is a flowchart of an example process for validating information. The process 200 can be performed by a computer system including one or more computers, such as, for example, the identifier validation system 110, as shown in FIG. 1.

Information related to a web property presented in response to a user request is received (202). For example, the system can receive information related to a web property (e.g., a reference to a product, service, hotel, or flight) when the web property is presented to a user. Web properties can be presented to a user in response to a user request for content from a web publisher. For example, using a web browser, a user can submit a query to a web publisher to obtain a list of hotels for a particular area. The web publisher can provide the user with a list of hotels, which can be presented to the user on the web browser. In particular, the presented hotels can include tags (e.g., client-side scripts) and/or pixels that are used to communicate information relating to the hotels to the system. For example, a user searching for luxury hotels can be presented with luxury hotels that are available in a particular area. Additionally, tags and/or pixels corresponding to the presented luxury hotels can be executed to communicate to the server information relating to the presented luxury hotels or the user.

Tags can be client-side scripts (e.g., JavaScripts) that are embedded within a document (e.g., an embedded script in an HTML web page) or a separate file that is referenced by the document (e.g., an external script). In particular, different tags can be associated with different web properties. The web browser can fire, or execute, the scripts and present web properties associated with the scripts. The scripts may also contain instructions for the web browser to execute in response to certain user actions, (e.g., clicking a button). In some implementations, the system receives information responsive to a tag that fires coincident with a presentation of a web property to the user. In some implementations, the client-side scripts can be configured to communicate information to the system in response to a presentation of a web property to the user.

In some other implementations, the system receives information responsive to a pixel that fires coincident with a presentation of a web property to the user. Pixels can be embedded within a document and can be associated with different web properties. A web browser that is processing a document with an embedded pixel will ordinarily retrieve image data for that pixel by sending a request to a particular server. In receiving this request from the web browser, the particular server can obtain various information about the client device on which the web browser is running (e.g., the IP address of the client device, the time the content was requested, the type of web browser that made the request, and the existence of cookies previously set by the particular server). The particular server can store all of this information for later use.

The system can receive various types of information in connection with the firing of tags and/or pixels coincident with the presentation of a web property to the user. In some implementations, the information is specified by the web publisher. For example, the web publisher can assign a particular identifier and name to a web property (e.g., “Product A” is assigned an identifier “1005” with a name “Generic Shoes #3151”). In some implementations, the information is in the form of a key pair. For example, the key pair can include a product name and identifier (e.g., “Generic Shoes #3151, 1005”). In some other implementations, the information includes product information associated with the web property. The product information associated with the web property can include a name, description, identifier, category, quantity, cost, event type (e.g., whether the product was purchased, placed in a shopping cart, or clicked on), and a timestamp indicating when the web property was presented to the user. In some implementations, the information includes an identifier. For example, an identifier can be a code (e.g., an alphanumeric code) that corresponds to the web property being identified. In some implementations, the identifier is a product identifier, a hotel identifier, or a flight identifier. In some implementations, identifiers can be used to identify a particular product (e.g., “Generic Shoes #3151”), a hotel (e.g., “Hotel XYZ, Manhattan, New York, N.Y.”), or a flight (e.g., “XYZ Airlines, Flight #100”). In some other implementations, the information includes travel information associated with the web property (e.g., origin; destination; whether the travel is for business or personal reasons; cost; whether the travel relates to a car rental, a hotel stay, or a flight booking; check-in date, check-out date, and event type).

Other details can be included in the information that is received by the system. In some implementations, the information includes user information that identifies the user. For example, the user information can be obtained based in part on the user being logged into a user account (e.g., associated with the browser, a toolbar, an application or the web publisher's website). In some implementations, the user information includes a cookie that identifies the user. A cookie can include a string of text stored on the client device by the web browser. The cookie can include one or more name-value pairs containing bits of information (e.g., a user identifier, user preferences, information in connection with a user's browsing habits, and other data used by websites). In particular, the received user information can be used to identify web properties (e.g., products) that were accessed by a particular user.

The system can use the received information for various purposes. In some implementations, the system forms one or more user lists using the information. User lists can represent a list of users that are characterized by specific information pertaining to predefined categories. The categories can be defined by the web publisher. For example, a user list may include data about one or more users which categorizes the users in a particular category (e.g., homeowner, craftsman, DVD renter, etc.). The categorization of users can assist with selection of relevant content by, for example, web publishers or advertisers. User lists can be generated and exchanged according to a number of rules, and those rules can be used to market particular user lists to specific consumers. The rules can employ methods of assigning users to particular user lists. Such rules can provide a logical categorization of data, information, or services for the purposes of determining which data content in the user lists is particularly relevant to a number of users. In some implementations, the system determines a user list is associated with the information and adds the user to the user list based on the information. In some implementations, the system determines when the information corresponds to an existing user list, and adds the user to the existing user list.

Returning to the method flow, the information is validated using a separate information source (204). In some implementations, the information includes a key pair including a product identifier and the system validates the information by locating the product identifier in data associated with a separate information source. For example, the system can validate a key pair including a product identifier by locating the product identifier in the separate information source. A product identifier can be validated when the product identifier is located in data associated with the separate information source. Alternatively, a product identifier may not be validated when the product identifier is unable to be located in data associated with the separate information source.

The separate information source can be provided by the web publisher and can include various information relating to web properties (e.g., identifier, name, description). For example, information relating to a product can be stored in the separate information source using an identifier “1005,” a name “Generic Shoes #3151,” and a description “All-weather waterproof shoes.” In some implementations, the separate information source is a product feed. In some implementations, the product feed is selected from a group comprising a product listings feed, a services listings, a hotel listings feed, or a flight listings feed.

The system can validate information received using other techniques. In some implementations, the system validates the information by determining whether the information is properly formatted. For example, the system can determine whether the information received is properly formatted by checking whether the information is in the proper case (e.g., “ABC123” instead of “abc123”). In some implementations, the system validates the information by determining whether the information is correctly encoded.

A record of invalid information is stored when the information is unable to be validated (206). In some implementations, the system stores a record by generating a report and providing the report to the web publisher, where the report includes the invalid information. For example, the report can include a list of invalid identifiers for which a corresponding identifier could not be located in a separate information source. A web publisher can use the report to identify and correct errors in connection with web properties that are presented on their websites.

In some implementations, the system enables the web publisher to select content that is relevant to the user based on the validated information. For example, the system can use the information to classify a particular user in a category (e.g., homeowner, craftsman, DVD renter, etc.), where a web publisher can use the user's classification to select relevant advertising content. The selection of content for users can be based on various criteria. In some implementations, the web publisher selects content for the user by receiving different bids based on the information. In some other implementations, the system enables the web publisher to provide different bids based on the information. For example, a user that is determined to have a preference for luxury hotels can be provided with content relating to luxury hotels. In particular, advertisers can target content to that user by bidding for advertising slots that will be presented to the user. In some other implementations, the system enables a different entity to select and provide content to the user based on the information.

FIG. 3 illustrates an interaction between a client device 304 and an example system for validating information 300. In general, the system 300 includes a client device 304, a publisher system 306, and an identifier validation system 308 in communication with an identifier feed 310.

In FIG. 3, a user 302 uses a graphical user interface (e.g., a web browser) to interact with a client device 304 to access a website that is managed by the publisher system 306. The publisher system 306 provides a website that includes a product listing 312, including products 314, 316, 318, and 320. The products 314, 316, 318, and 320 correspond to product identifiers 653, 104, 826, and 216, respectively. In particular, the products 314, 316, 318, and 320 can be associated with tags (e.g., client-side scripts) that execute when the products 314, 316, 318, and 320 are presented to the user 302. The products 314, 316, 318, and 320 can also be associated with a pixel that communicates information when the products 314, 316, 318, and 320 are presented to the user 302.

In some implementations, the product identifiers 104, 216, 653, and 826 are communicated to the identifier validation system 308 in response to a tag and/or pixel that fires or is executed coincident with a presentation of the products 314, 316, 318, and 320 to the user 302. In response to the firing of the tags and/or pixels, the product identifiers 104, 216, 653, and 826, which correspond to the products 314, 316, 318, and 320, are communicated to the identifier validation system 308 for validation.

The identifier validation system 308 validates information received from the client device 304. In some implementations, the information includes a key pair including a product identifier, where the information is validated by locating the product identifier in data associated with a separate information source. In FIG. 3, the identifier validation system 308 validated each received product identifier by locating the product identifier in data associated with the identifier feed 310. In some implementations, a product identifier is validated when the product identifier can be located in data associated with the identifier feed 310. Alternatively, a product identifier is not validated when the product identifier cannot be located in data associated with the identifier feed 310.

The validation results table 322 illustrates the results of the validation process. In particular, the validation results table 322 indicates that products 316 and 318, which correspond to product identifiers 104 and 826, respectively, are validated, since the product identifiers were able to be located in the data associated with the identifier feed 310. The validation results table 322 also indicates that products 314 and 320, which correspond to product identifiers 653 and 216, respectively, are not validated, since the product identifiers could not be located in the data associated with the identifier feed 310.

In some implementations, a record indicative of any invalid information is stored when information is unable to be validated. In some implementations, the storing of information includes generating a report and providing the report to the web publisher, the report including the invalid information. The identifier validation system 308 can generate a report 324 that includes a listing of products that were unable to be validated. The report 324 can correspond to the results shown in the validation results table 322. In particular, the report 324 can indicate that product identifiers 653 and 216, which correspond to the products 314 and 320, respectively, could not be validated by the identifier validation system 308. The report 324 is provided to the publisher system 306 for further processing. The publisher system 306 can use the report 324 to correct product identifiers associated with the products 314 and 320, such that firing of tags and/or pixels in response to presentation of the products 314 and 320 results in communication of the correct product identifiers for the products 314 and 320.

For situations in which the systems discussed here collect personal information about users, the users may be provided with an opportunity to opt in/out of programs or features that may collect personal information (for example, information about a user's social network, social actions or activities, a user's preferences, or a user's current location). In addition, certain data may be anonymized in one or more ways before it is stored or used, so that personally identifiable information is removed. For example, a user's identity may be anonymized so that the no personally identifiable information can be determined for the user, or a user's geographic location may be generalized where location information is obtained (such as to a city, ZIP code, or state level), so that a particular location of a user cannot be determined. In some implementations, opt out features related to social networking systems, for example, can allow the user to specify that the user's activity stream content is not to be used in content selection, or to anonymize the information in some way. Further, in situations in which information is gathered and stored related to the subject matter of communications among users, the information can be aggregated (for example, to a keyword level), personal information can be omitted (for example, not stored), and the information can be associated with users using anonymized user identifiers.

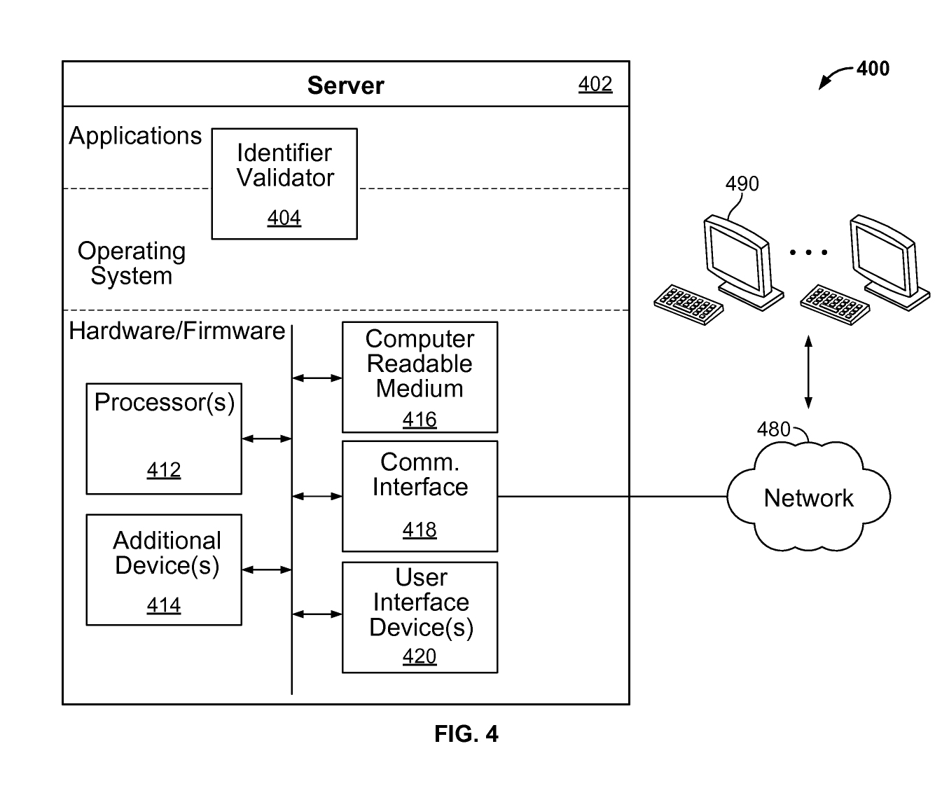

FIG. 4 is a schematic diagram of an example server 402. The server 402 is optionally connected to one or more user or client computers 490 through a network 480. The server 402 consists of one or more data processing apparatuses. While only one data processing apparatus is shown in FIG. 4, multiple data processing apparatus can be used. The server 402 includes various software modules, e.g. executable software programs or libraries, including an identifier validation module 404. Although several software modules are illustrated, there may be fewer or more software modules. Moreover, the software modules can be distributed on one or more data processing apparatus connected by one or more networks or other suitable communication mediums.

The server 402 also includes hardware or firmware devices including one or more processors 412, one or more additional devices 414, a computer readable medium 416, a communication interface 418, and one or more user interface devices 420. Each processor 412 is capable of processing instructions for execution within the server 402. In some implementations, the processor 412 is a single or multi-threaded processor. Each processor 412 is capable of processing instructions stored on the computer readable medium 416 or on a storage device such as one of the additional devices 414. The server 402 uses its communication interface 418 to communicate with one or more client computers 490, for example, over a network 480.

Examples of user interface devices 420 include a display, a camera, a speaker, a microphone, a tactile feedback device, a keyboard, and a mouse. The server 402 can store instructions that implement operations associated with the modules described above, for example, on the computer readable medium 416 or one or more additional devices 614, for example, one or more of a floppy disk device, a hard disk device, an optical disk device, or a tape device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving information from a web publisher related to a presentation of a web property responsive to a user request, the information including an identifier associated with the content presented and an identifier associated with the user that viewed the web property;
validating the information that was received from the web publisher and that is related to the presentation of the web property, the validating including determining when the information is properly encoded and/or formatted by comparing the information to data stored in a separate information source that is provided by the web publisher, wherein the information includes one or more of the identifier and a description associated with the content presented; and
when the information is unable to be validated, storing a record indicative of any invalid information.

2. The method of claim 1 where the information is in a form of a key pair.

3. The method of claim 1 where the information includes product information associated with the web property.

4. The method of claim 1 where the identifier is selected from a group comprising a product identifier, a service identifier, a hotel identifier, or a flight identifier.

5. The method of claim 1 where the information is received responsive to a tag or pixel that fires coincident with a presentation of the web property to the user.

6. The method of claim 1 where the information is specified by the web publisher.

7. The method of claim 1 where the user information includes a cookie that identifies the user.

8. The method of claim 1 further comprising forming a user list using the information.

9. The method of claim 1 further comprising determining a user list associated with the information and adding the user to the user list based on the information.

10. The method of claim 1 where the information includes a key pair including a product identifier, and where validating the information comprises locating the product identifier in data associated with the separate information source.

11. The method of claim 1 further comprising determining when the information corresponds to an existing user list, and adding the user to the user list.

12. The method of claim 1 where the separate information source is a product feed and wherein the product feed is selected from a group comprising a product listings feed, a service listings feed, a hotel listings feed, or a flight listings feed.

13. The method of claim 1 further comprising enabling the web publisher to target content to the user based on the information and wherein the targeting includes either receipt of different bids based on the information or enabling the web publisher to provide different bids based on the information.

14. The method of claim 1 further comprising enabling a different entity to target content to the user based on the information.

15. A method comprising:
receiving, coincident with a presentation of a web resource, information from a web publisher associated with the web resource that identifies tag attributes to be associated with a user viewing the web resource;
validating the information that was received from the web publisher and that is associated with the web resource that identifies tag attributes to be associated with the user viewing the web resource, the validating including validating one or more of the tag attributes against data stored in a separate information source that includes feed attributes where the feed attributes are used in developing one or more user lists, each user list being associated with a respective feed attribute and including respective identifiers for one or more users that are associated with the user list and are characterized by the respective feed attribute; and
when the information is invalid, providing a report to the web publisher that includes invalid information.

16. A system comprising:
one or more computers; and
one or more computer-readable storage devices, coupled to the one or more computers, to perform operations comprising:
receiving information from a web publisher related to a presentation of a web property responsive to a user request, the information including an identifier associated with the content presented and an identifier associated with the user that viewed the web property;
validating the information that was received from the web publisher and that is related to the presentation of the web property, the validating including determining when the information is properly encoded and/or formatted by comparing the information to data stored in a separate information source that is provided by the web publisher, wherein the information includes one or more of the identifier and a description associated with the content presented; and
when the information is unable to be validated, storing a record indicative of any invalid information.

17. The system of claim 16 where the information is in a form of a key pair.

18. The system of claim 16 where the identifier is selected from a group comprising a product identifier, a service identifier, a hotel identifier, or a flight identifier.

19. The system of claim 16 where the information is received responsive to a tag or pixel that fires coincident with a presentation of the web property to the user.

20. The system of claim 16 further comprising forming a user list using the information.

21. The system of claim 16 further comprising determining a user list associated with the information and adding the user to the user list based on the information.

22. A computer storage medium encoded with a computer program, the program comprising instructions that when executed by data processing apparatus cause the data processing apparatus to perform operations comprising:
receiving information from a web publisher related to a presentation of a web property responsive to a user request, the information including an identifier associated with the content presented and an identifier associated with the user that viewed the web property;
validating the information that was received from the web publisher and that is related to the presentation of the web property, the validating including determining when the information is properly encoded and/or formatted by comparing the information to data stored in a separate information source that is provided by the web publisher, wherein the information includes one or more of the identifier and a description associated with the content presented; and
when the information is unable to be validated, storing a record indicative of any invalid information.

23. The computer storage medium of claim 22 where the information is in a form of a key pair.

24. The computer storage medium of claim 22 where the identifier is selected from a group comprising a product identifier, a service identifier, a hotel identifier, or a flight identifier.

25. The computer storage medium of claim 22 where the information is received responsive to a tag or pixel that fires coincident with a presentation of the web property to the user.
